(19) United States
(12) Patent Application Publication
(10) Pub. No.: US 2022/0193583 A1
(43) Pub. Date: Jun. 23, 2022

(54) Fluid-Purifying Element of a Fluid-Purifying System for Purifying Liquid Fluid, Fluid-Purifying System, and Sealing Element of a Fluid-Purifying Element

(71) Applicant: MANN+HUMMEL GmbH, Ludwigsburg (DE)

(72) Inventors: Arndt-Udo ROLLE, Stuttgart (DE); Frank PFLUEGER, Sachsenheim (DE)

(21) Appl. No.: 17/692,295

(22) Filed: Mar. 11, 2022

Related U.S. Application Data
(63) Continuation of application No. PCT/EP2020/071857, filed on Aug. 4, 2020.

(30) Foreign Application Priority Data
Sep. 11, 2019 (DE) 10 2019 124 432.3

(51) Int. Cl. B01D 35/30

(52) U.S. Cl. CPC B01D 35/30; B01D 2201/40; B01D 2201/347

(57) ABSTRACT

A fluid-purifying element has a purifying medium delimiting an element interior. An end body is disposed at an axial end face of the purifying medium and has a radially outer circumferential side provided with an elastic annular seal element. The end body has an end body holding contour for the seal element that extends at least in sections continuously circumferentially at the radially outer circumferential side. The seal element has a seal holding contour arranged at a radially inner circumferential side thereof. The seal element has a seal surface extending at least across a portion of a radially outer circumferential side thereof. The end body holding contour has a protrusion extending at least part-circumferentially and radially outwardly. The protrusion tapers radially outwardly. The seal holding contour has a V-shaped depression extending at least part-circumferentially and radially outwardly. The end body holding contour engages the seal holding contour.

### CROSS-REFERENCE TO RELATED APPLICATIONS

This application is a continuation application of international application No. PCT/EP2020/071857 having an international filing date of 4 Aug. 2020 and designating the United States, the international application claiming a priority date of 11 Sep. 2019 based on prior filed German patent application No. 10 2019 124 432.3, the entire contents of the aforesaid international application and the aforesaid German patent application being incorporated herein by reference.

### BACKGROUND OF THE INVENTION

The invention concerns a fluid-purifying element of a fluid-purifying system for purifying liquid fluid, comprising at least one purifying medium which at least partially delimits at least one element interior, at least one end body which is arranged axially at an end face in relation to a virtual axis at the fluid-purifying element, and at least one elastic annular seal element which is arranged at a radially outer circumferential side, in relation to the virtual axis, of the at least one end body, wherein the at least one end body comprises at least one end body holding contour for the at least one seal element which extends at least in sections continuously circumferentially at a radially outer circumferential side, in relation to the virtual axis, of the at least one end body, wherein the at least one seal element comprises at its radially inner circumferential side, in relation to the axis, a seal holding contour which contacts at least in sections the end body holding contour of the at least one end body, wherein the at least one seal element comprises at least one seal surface which extends at least across a portion of the radially outer circumferential side, in relation to the axis, of the at least one seal element.

Furthermore, the invention concerns a fluid-purifying system for purifying liquid fluid, with a filter housing comprising at least a first housing part and a second housing part, with at least one fluid inlet for fluid to be purified and at least one fluid outlet for purified fluid, wherein in the filter housing at least one fluid purifying element is exchangeably arranged such that it separates the at least one fluid inlet from the at least one fluid outlet, wherein the at least one fluid-purifying element comprises at least one purifying medium which at least partially delimits at least one element interior, at least one end body which is arranged axially at an end face in relation to a virtual axis at the at least one fluid-purifying element, and at least one elastic annular seal element which is arranged at a radially outer circumferential side, in relation to the axis, of the at least one end body, wherein the at least one end body comprises at least one end body holding contour for the at least one seal element which extends at least in sections continuously circumferentially at the radially outer circumferential side, in relation to the axis, of the at least one end body, wherein the at least one seal element comprises, at its radially inner circumferential side in relation to the axis, a seal holding contour which at least in sections contacts the end body holding contour of the at least one end body, wherein the at least one seal element comprises at least one seal surface which extends at least across a portion of the radially outer circumferential side, in relation to the axis, of the at least one seal element, wherein the at least one seal element sealingly contacts respectively at least an end body support surface of the at least one end body, at least one first housing seal contact surface of the first housing part, and at least one second housing seal contact surface of the second housing part.

Moreover, the invention concerns a seal element of a fluid-purifying element for a fluid-purifying system for purifying liquid fluid, wherein the seal element is elastic and annular and comprises at its radially inner circumferential side in relation to an axis a seal holding contour, and wherein the seal element comprises at least one seal surface which extends at least across a portion of the radially outer circumferential side, in relation to the axis, of the at least one seal element.

WO 2018/033317 A1 discloses a filter element arrangement, in particular for fuel filtration, preferably with water separation, comprising a filter element with at least one annular filter bellows, to be flowed through in particular radially, and at least one end disk arranged at an end face at the filter bellows as well as comprising at least one circumferentially extending seal element arranged at the end disk. The seal element, for intended use in a filter system, is provided for sealing clean side relative to raw side of the filter element as well as, by compression between a first housing part and a second housing part of the filter system, for sealing a housing interior of the filter system relative to an environment of the filter system.

The invention has the object to design a fluid-purifying element, a fluid-purifying system, and a seal element of the aforementioned kind in which an expenditure for arranging the at least one seal element at the at least one end body can be reduced and/or a function and/or reliability of the at least one seal element can be improved.

### SUMMARY OF THE INVENTION

The object is solved according to the invention for the fluid-purifying element in that the at least one end body holding contour comprises at least one protrusion which, in relation to the axis, extends at least part-circumferentially and radially outwardly and tapers in radial direction from the interior to the exterior, and at least one seal holding contour comprises at least one V-shaped depression which, in relation to the axis, extends at least part-circumferentially and radially outwardly, wherein the at least one end body holding contour engages at least partially in the at least one seal holding contour.

According to the invention, a protrusion is provided on the part of the at least one end body and engages at least one corresponding depression on the part of the seal element. Due to the depression, the material expenditure of the at least one seal element according to the invention is correspondingly reduced in comparison to a seal element that is known from the prior art. Moreover, due to the protruding end body holding contour, a force transmission between the at least one seal element and the at least one end body is improved. The protrusion of the at least one end body holding contour, which tapers in radial direction from the interior to the exterior, can be introduced precisely into the at least one seal holding contour so that the seat of the at least one seal element at the at least one end body is further improved. As a whole, the function and the reliability of the at least one seal element can thus be improved.

Advantageously, the at least one seal element can be arranged on at least one end body which, as intended, is located spatially at the bottom. In this manner, by means of the at least one seal element, at least one region spatially above the at least one end body can be sealed relative to at least one region spatially below the at least one end body.

Advantageously, the at least one end body can be designed as an end disk. In axial direction in relation to the axis, end disks can be designed flat and thus in a space-saving manner.

Advantageously, at least one fluid-purifying element can be a filter element. With a filter element, particles can be filtered out of the fluid to be purified. Correspondingly, the fluid-purifying system can be a fluid filtration system.

As an alternative, the fluid-purifying element can be advantageously a water separation element. With a water separation element, water that is entrained in the fluid to be purified can be separated. Correspondingly, the fluid-purifying system can be a fluid-water separation system.

Alternatively, the fluid-purifying element can be a combined filter-water separator element. In this manner, particles as well as water can be separated from the fluid to be purified by means of the fluid-purifying element.

The fluid-purifying element can be advantageously a so-called round element, in particular a round filter element.

The purifying medium can advantageously be circumferentially closed or open in relation to the axis. The purifying medium can be in particular star-shaped, preferably zigzag-shaped or corrugated, folded, or curved. The purifying medium can also be not folded or not curved.

The purifying medium can be a filter paper, a filter nonwoven, filter foam, meltblown, nonwoven, fabric, or a filter medium of a different kind that is suitable for filtering liquid fluid, or a combination of different filter media. The purifying medium can be a single layer or multi-layered. Advantageously, the purifying medium can be foldable and/or bendable.

The fluid-purifying element can advantageously be a part of a fuel filter or motor oil filter of an internal combustion engine, in particular of a motor vehicle. The invention is however not limited to motor oil filters or fuel filters of internal combustion engines of motor vehicles. Instead, it can also be used for other kinds of liquid systems, in particular hydraulic systems, cooling systems, fluid systems with urea-water solution or the like, of motor vehicles or other machines, in particular agricultural machines or construction machines. The liquid filter can also be used outside of the automotive technology, in particular in industrial motors.

The invention can be used in motor vehicles, in particular passenger cars, trucks, buses, agricultural and/or construction vehicles, construction/agricultural machines, compressors, industrial motors or other apparatus, in particular with internal combustion engines. The invention can be used in land craft, watercraft, and/or aircraft.

In an advantageous embodiment, at least one end body holding contour can comprise a V-shaped or U-shaped profile.

In case of a V-shaped profile, the flanks of the end body holding contour or of the seal holding contour can extend at a slant in relation to each other. In this manner, seal contact surfaces or seal surfaces acting in axial direction and in radial direction can be realized with the flanks. Since the protrusion according to the invention tapers in radial direction from the interior to the exterior, one can also speak of a cross section in the form of a “V” opening toward the interior. In case of a V-shaped profile, the material expenditure for the at least one seal element can be further reduced.

Alternatively, at least one end body holding contour can be realized also in particular as an arbitrary convex geometry. Advantageously, at least one end body holding contour, in particular at least one end body holding contour with a convex geometry, can form two tangents that are in particular mirror-symmetrically positioned relative to each other.

Accordingly, at least one V-shaped seal holding contour can form two tangents that are in particular mirror-symmetrically positioned to each other.

In a further advantageous embodiment, an angle between the flanks of at least one V-shaped end body holding contour can amount to approximately between 25° and 70° and/or an angle between the flanks of at least one V-shaped seal holding contour can amount to approximately between 25° and 70°. It has been found that a good stability and a good sealing action can be obtained within this angle range.

In a further advantageous embodiment, the at least one seal element can comprise at least one seal element support surface at its radially inner circumferential side in relation to the axis, wherein at least a portion of the at least one seal element support surface is configured as a seal surface and/or the at least one end body can comprise at least one end body support surface at its radially outer circumferential side in relation to the axis, wherein at least a portion of the at least one end body support surface is configured as a seal surface. In this manner, at least one seal element support surface of the at least one seal element can sealingly contact at least one portion of the at least one end body support surface of the at least one end body. In this manner, a supporting and/or sealing action between the at least one seal element and the at least one end body can be improved. By means of the radially inwardly oriented at least one seal element support surface and the radially outwardly oriented at least one end body support surface, a bypass of flow past the fluid-purifying element can be prevented.

Advantageously, at least one seal element support surface can be arranged in the region of the at least one depression of the at least one seal holding contour. In this manner, a supporting and/or sealing action can be improved in the region of the depression.

Alternatively or additionally, at least one seal element support surface can be advantageously arranged outside of at least one depression of the at least one seal holding contour. In this manner, a supporting and/or sealing action can be improved outside of the depression.

In a further advantageous embodiment, at least two radially inwardly oriented seal element support surfaces can be arranged in particular symmetrically on axially oppositely positioned sides of at least one V-shaped depression and/or at least two radially outwardly oriented end body support surfaces can be arranged in particular symmetrically on axially oppositely positioned sides of at least one protrusion of the at least one end body holding contour. In this manner, the supporting and/or sealing action can be further improved.

Advantageously, at least one seal element support surface in the region of the at least one depression can sealingly interact with a corresponding end body support surface at the at least one protrusion of the at least one end body holding contour. At least one seal element support surface in a region outside of the at least one depression of the at least one seal element can interact supportingly and/or sealingly with corresponding end body support surfaces on the part of the at least one end body.

Alternatively or additionally, at least one end body support surface can be advantageously arranged in the region of the at least one protrusion of the at least one end body holding contour. In this manner, the end body support surface can interact with the corresponding seal element support surface on the part of the at least one seal element.

Alternatively or additionally, at least one end body support surface can be advantageously arranged outside of the at least one protrusion. In this manner, the at least one end body support surface can interact supportingly and/or sealingly with at least one seal element support surface outside of the at least one depression of the at least one seal holding contour.

Advantageously, at least one seal element support surface of the at least one seal element can extend continuously at its radial inner circumferential side in relation to the axis. In this manner, an areally continuous supporting and/or sealing action can be obtained. The seal element support surface can extend across regions within the depression of the seal holding contour and regions outside of the depression of the seal holding contour. In this manner, the seal element support surface and thus the supporting and/or sealing action can be further enlarged.

Advantageously, at least one end body support surface of the at least one end body can extend continuously at its radially outer circumferential side in relation to the axis. In this manner, an areally continuous supporting and/or sealing action can be obtained. The at least one end body support surface can extend across regions within the protrusion of the end body holding contour and regions outside of the protrusion of the end body holding contour. In this manner, the end body support surface and thus the supporting and/or sealing action can be further enlarged.

In a further advantageous embodiment, at least one seal element can comprise an arc-shaped profile at its radially outer circumferential side in relation to the axis. In this manner, the at least one seal element can act sealingly in relation to the axis in axial and radial direction.

Advantageously, at least one seal element can be designed as a so-called half-moon seal or as a hexagonal seal. In this manner, at different locations of the at least one seal element and/or in different directions, in particular in axial and/or radial direction, a corresponding sealing action can be realized. The at least one seal element can be adapted in this way to spatial conditions of a filter housing in which the fluid-purifying element will be arranged. In a further advantageous embodiment, at least one seal element can comprise at least one axial projection on at least one axial side in relation to the axis. By means of an axial projection, the at least one seal element can engage regions which project in axial direction past the fluid-purifying element, in particular the at least one end body.

In a further advantageous embodiment, at least one seal element can comprise at least one seal surface at least at one axial end face in relation to the axis. In this manner, a corresponding sealing action in axial direction can be realized with the at least one seal element.

Advantageously, the at least one seal surface of the at least one seal element can extend from the radial outer circumferential side across at least one axial end face.

In this manner, the at least one seal element can sealingly contact corresponding seal contact surfaces, in particular on the part of at least one housing part of a filter housing.

In a further advantageous embodiment, at least one end body can be realized with at least one seal element as a multi-component structure and/or at least one seal element can be fastened to at least one end body so as to be separable or separable only destructively. A multi-component structure can be realized simply and precisely.

Alternatively, the at least one seal element can be fastened to at least one end body so as to be separable or separable only destructively. In this manner, the at least one seal element can be produced separate from the at least one end body and can be assembled subsequently.

Advantageously, the at least one seal element can be connected to the at least one end body by means of a material-fused and/or form-fit and/or friction-fit connection, in particular by means of gluing, vulcanizing, a plug connection, snap connection, clamping connection or the like.

Advantageously, the at least one seal element can be arranged so as to be separable non-destructively at the at least one end body. In this manner, the at least one seal element can be separated from the at least one end body in particular for maintenance purposes.

Advantageously, the at least one end body can comprise at least one material opening into or through which the material of the at least one seal element can extend or pass. In this manner, the connection between the at least one seal element and the at least one end body can be improved.

The at least one material opening can advantageously be an opening for through injection. Advantageously, the material for the at least one seal element can be integrally formed in particular by means of an injection molding method on the at least one end body. In this context, the material for the at least one seal element can flow into or through at least one opening for through injection. In this manner, the connection between the at least one seal element and the at least one end body can be improved.

In a further advantageous embodiment, the at least one end body can comprise at least one fluid connection to the element interior. In this manner, for installed fluid-purifying element in a filter housing, the element interior can be connected to corresponding fluid connections or fluid-conducting spaces of the filter housing.

Advantageously, the at least one end body can comprise at least one water discharge opening and/or at least one fluid opening for the fluid to be purified or for purified fluid which are connected to at least one element interior.

Advantageously, at least one water discharge opening of the at least one end body can connect at least one element interior to at least one water collection chamber. In this manner, the separated water of the at least one element interior can be collected in the at least one water collection chamber.

Alternatively or additionally, the at least one end body can comprise a fluid opening through which—depending on the flow direction of the fluid to be purified through the fluid-purifying element—fluid to be purified can flow into the element interior or purified fluid out of the element interior.

In a further advantageous embodiment, at least one purifying medium can be designed as a filter medium and surround at least one element interior, and at least a part of at least one water separation device can be arranged in the at least one element interior. In this manner, the fluid-purifying element as a whole can be designed more compact. Water that is entrained by the fluid to be purified can be separated by means of the water separation device. Upon flow through the purifying medium in radial direction from the interior to the exterior, the water can thus be separated after filtering the fluid to be purified.

Through at least one water discharge opening of the at least one end body, water that has been separated from the fluid to be purified by the water separation device can flow out of the element interior.

In a further advantageous embodiment, at least one end body can be provided as one piece together with the at least one end body holding contour, and/or at least one end body can be designed as a multi-part configuration with at least one end body holding contour. A one piece connection can be realized simply and stably. In case of a multi-part connection, the at least one end body holding contour can be realized at a separate holding component. The separate holding component with the at least one end body holding contour can be produced separately from the remaining end body and assembled subsequently.

Advantageously, at least one end body holding contour can be mounted on at least one holding component of the at least one end body so as to be detachable or detachable only destructively. In this manner, the at least one end body holding contour can be of a modular design.

In a further advantageous embodiment, at least one further end body can be arranged on the side of the at least one purifying medium which, in relation to the axis, is axially oppositely positioned to the at least one end body with the at least one seal element. In this manner, the at least one purifying medium can be supported on oppositely positioned sides by an end body.

Moreover, the object is solved according to the invention for the fluid-purifying system in that the at least one end body holding contour comprises at least one protrusion, which extends in relation to the axis at least part-circumferentially and radially outwardly, and at least one V-shaped seal contour comprises at least one depression, which extends in relation to the axis at least part-circumferentially and radially outwardly, wherein the at least one end body holding contour engages at least partially in the at least one seal holding contour.

Advantageously, the fluid-purifying system can comprise at least one fluid-purifying element according to the invention.

Also, the object is solved according to the invention for the seal element in that the at least one seal holding contour comprises at least one V-shaped depression which, in relation to the axis, extends at least part-circumferentially and radially outwardly.

Advantageously, the seal element can be configured for a fluid-purifying element according to the invention and/or a fluid-purifying system according to the invention.

In other respects, the features and advantages which have been explained in relation to the fluid-purifying element according to the invention, the fluid-purifying system according to the invention, and the seal element according to the invention and their respective advantageous embodiments apply among each other and vice versa. Of course, the individual features and advantages can be combined among each other, wherein further advantageous effects can be obtained which go beyond the sum of the individual effects.

### BRIEF DESCRIPTION OF THE DRAWINGS

Further advantages, features, and details of the invention result from the following description in which an embodiment of the invention will be explained in more detail with the aid of the drawing. A person of skill in the art will consider the features disclosed in the drawing, description, and the claims in combination expediently also individually and combine them to expedient further combinations.

FIG. 1 shows a longitudinal section of a fluid-purifying system for liquid fluid according to a first embodiment, with a filter element which is arranged in a filter housing and which comprises, at a bottom end body, a seal element for sealing in relation to the filter housing.

FIG. 2 shows a detail view of the fluid-purifying system of FIG. 1 in the region of the bottom end body with the seal element.

FIG. 3 shows a longitudinal section of the seal element of the filter element of FIGS. 1 and 2.

FIG. 4 shows a longitudinal section of a water separator element of a fluid-purifying system according to a second embodiment.

In the Figures, same components are identified with same reference characters.

### DESCRIPTION OF PREFERRED EMBODIMENTS

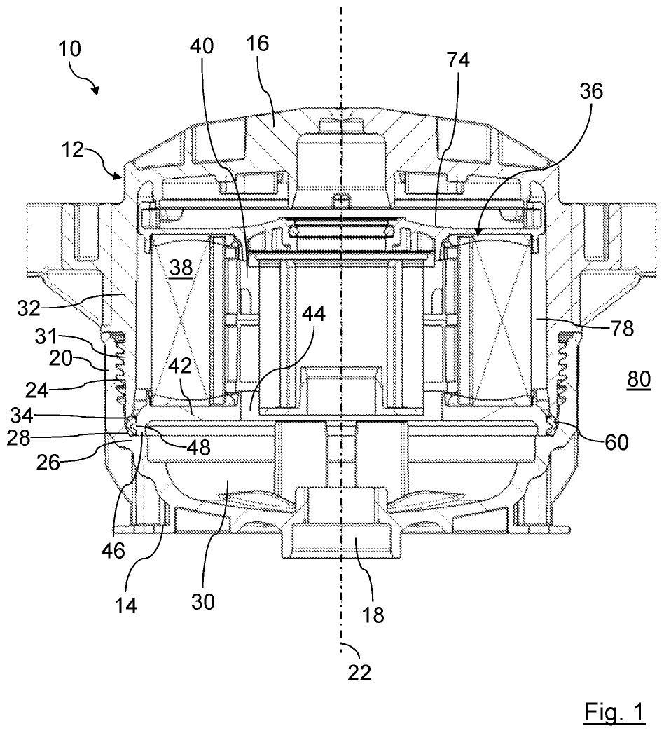

In FIG. 1, a fluid-purifying system 10 in the form of a combined filter-water separator system for purifying liquid fluid, for example, fuel or motor oil, is illustrated in a longitudinal section. The fluid-purifying system 10 can be arranged in a liquid conduit, for example, a fuel conduit or motor oil conduit of an internal combustion engine. The internal combustion engine can be a part of a motor vehicle.

The fluid-purifying system 10 comprises a filter housing 12 with a first housing part 14 that is cup-shaped as an example, in FIG. 1 at the bottom, and a second housing part 16 at the top that is cup-shaped as an example. The filter housing 12 comprises a fluid inlet for fluid to be purified and a fluid outlet for purified fluid which are both hidden in the illustration in FIG. 1 and therefore not illustrated.

In addition, the filter housing 12 comprises a water drain 18 through which water that has been separated from the fluid by the fluid-purifying system 10 can be drained from the filter housing 12. The water drain 18 is located in an exemplary fashion in the bottom of the first housing part 14.

A circumferential wall 20 of the first housing part 14, in the region of its free rim at its inner side, is circular cylindrical and coaxial to an axis 22.

When in the following “radial”, “axial”, “coaxial”, “circumferential” or the like is mentioned, this relates to the axis 22, provided nothing to the contrary is mentioned.

In the region of the free rim, the circumferential wall 20 comprises an inner thread 24. At the side of the inner thread 24 facing axially away from the free rim, the circumferential wall 20 passes into a step 26. The step 26 extends radially inwardly.

The radially inner circumferential side of the circumferential wall 20 comprises a first housing seal contact surface 28. The first housing seal contact surface 28 extends from the inner thread 24 across the step 26. The first housing seal contact surface 28 is circumferentially continuous.

At the bottom side facing away from the inner thread 24, the first housing part 14 comprises a water collection chamber 30.

The second housing part 16 comprises, in the region of the free rim of its circumferential wall 32, a coaxial outer thread 31 which matches the inner thread 24. The free rim of the circumferential wall 32 comprises a second housing seal contact surface 34. The second housing seal contact surface 34 is circumferentially continuous. The second housing seal contact surface 34 is oriented at a slant radially inwardly toward the first housing part 14.

In the filter housing 12, a fluid-purifying element in the form of a filter element 36 is arranged such that it separates the fluid inlet of the filter housing 12 from the fluid outlet. As an example, the filter element 36 is a so-called round filter element.

The filter element 36 comprises a purifying medium in the form of a filter medium 38 which surrounds circumferentially continuously an element interior 40 through which the axis 22 extends.

The filter medium 38 is comprised of a material which is permeable for the fluid to be purified and that is suitable for filtering the fluid. For example, the filter medium 38 can comprise or be comprised of filter nonwoven, filter paper or the like.

At the axial bottom end face of the filter medium 38 which is facing the first housing part 14, a first end body 42 is fastened. The first end body 42 has the shape of an annular disk and can be referred to as end disk. The first end body 42 serves for closing off the filter medium 38 at the end face and for mechanical stabilization.

The first end body 42 comprises a coaxial water outlet opening 44. The water outlet opening 44 forms a liquid connection between the element interior 40 and the water collection chamber 30.

At its side facing away from the filter medium 38, the first end body 42 comprises a circular cylindrical holding region 46 in the region of its radial outer rim.

At the radially outer circumferential side of the holding region 46, a circumferentially continuous end body holding contour 48 in the form of a protrusion is arranged. The end body holding contour 48 has an approximately V-shaped profile, wherein the radially outer tip is rounded. The end body holding contour 48 is extending in an exemplary fashion symmetrically in relation to a virtual section plane 50 which is perpendicular to the axis 22. A respective angle 52 between the flanks 54 amounts to approximately 65°.

The regions of the radially outer circumferential side of the holding region 46 above and below the end body holding contour 48 extend circumferentially and in axial direction.

At its radially outer circumferential side, the holding region 46 comprises a circumferentially continuous radially outer end body support surface 56. The radially outer end body support surface 56 extends continuously across the axial region above and the axial region below the end body holding contour 48 and along the end body holding contour 48.

The holding region 46 comprises a support region 58 at its free end face rim. The support region 58 is flat and extends radially and circumferentially. By means of the support region 58, the filter element 36 is supported against the step 26 of the first housing part 14.

On the holding region 46 of the first end body 42, a circular annular elastic seal element 60 is arranged. One side of the seal element 60 is illustrated in profile in FIG. 3. The seal element 60 is comprised of a flexible, for example, elastic, seal material. For example, the seal element 60 is designed as a so-called half-moon seal.

At its radially inner circumferential side, the seal element 60 comprises a seal holding contour 62 in the form of a depression. The seal holding contour 62 has, for example, an approximately V-shaped profile wherein the tip is rounded. The seal holding contour 62 is open toward the radially inner circumferential side. The seal holding contour 62 is approximately complementary to the end body holding contour 48.

The seal element 60 is symmetrical in relation to the section plane 50. An angle between the flanks 64 of the seal holding contour 62 corresponds to the angle 52 on the part of the end body holding contour 48 with, for example, approximately 65° and, for better clarity, is provided with the same reference character 52. In regions axially adjacent to the seal holding contour 62, in FIGS. 1 to 3 above and below, the radially inner circumferential side of the seal element 60 extends axially and circumferentially.

The radially inner circumferential side of the seal element 60 forms a radially inner seal element support surface 66. The radially inner seal element support surface 66 is comprised of a contour support surface section 66a within the seal holding contour 62 and two radial support surface sections 66b in the region of the two regions adjoining the seal holding contour 62. Contour support surface section 66a passes continuously into the radial support surface sections 66b, respectively. The radially inner seal element support surface 66 extends as a whole across the entire radially inner circumferential side of the seal holding contour 62. The seal element support surface 66 with the contour support surface section 66a and the radial support surface sections 66b serves as support surface with sealing action in relation to the end body 42 or the end body holding contour 48.

The two radially inwardly oriented radial support surface sections 66b are symmetrically arranged at axially oppositely positioned sides of the V-shaped depression of the seal holding contour 62.

At the level of the radial support surface sections 66b, the seal element 60 has a continuous radial expansion 82, for example, of at least approximately 2.7 mm.

In the region of the flanks 64, the contour support surface section 66a extends at an angle in relation to the normal direction relative to the axis 22 (see section plane 50), i.e., not exclusively in radial direction and not exclusively in axial direction. The contour support surface section 66a contacts the end body support surface 56 in axial direction as well as in radial direction, acting sealingly, in the region of the flanks 54 of the end body holding contour 48. Outside of the seal holding contour 62, the radial support surface sections 66b contact in radial direction sealingly the axial regions of the end body support surface 56.

Viewed in radial direction outwardly from the radially inner circumferential side, the seal element 60 widens first in axial direction and passes in the region of the oppositely positioned axial end faces into a respective axial projection 68.

The radially outer circumferential side of the seal element 60 is convexly curved in a region between the axial projections 68 viewed from a radially outer point. In profile, the radially outer circumferential side has the shape of a half moon.

The radially outer circumferential side of the seal element 60 forms a radially outer seal surface 70. At the axial projections 68, the radially outer seal surface 70 passes continuously into the respective axial seal surface 72, respectively.

The filter element 36 comprises moreover a second end body 74 at the side which is facing away axially from the first end body 42.

In the element interior 40, a water separation device 76 is additionally arranged with which water that is entrained in the fluid to be purified can be separated.

For installation, the filter element 36, with the filter housing 12 open, is inserted with the first end body 42 leading into the first housing part 14 in axial direction until the support region 58 of the first end body 42 contacts the step 26 of the first housing part 14. Subsequently, the second housing part 16 is screwed onto the first housing part 14.

Alternatively, the filter element 36, with the filter housing 12 open, can be inserted with the second end body 74 leading into the second housing part 16 in axial direction. The second housing part 16 with the filter element 36 held therein can subsequently be screwed into the first housing part 14. Upon screwing together the filter housing 12, the filter element 36 is moved into its end position in the first housing part 14 in which the support region 58 of the first end body 42 is contacting the step 26 of the first housing part 14.

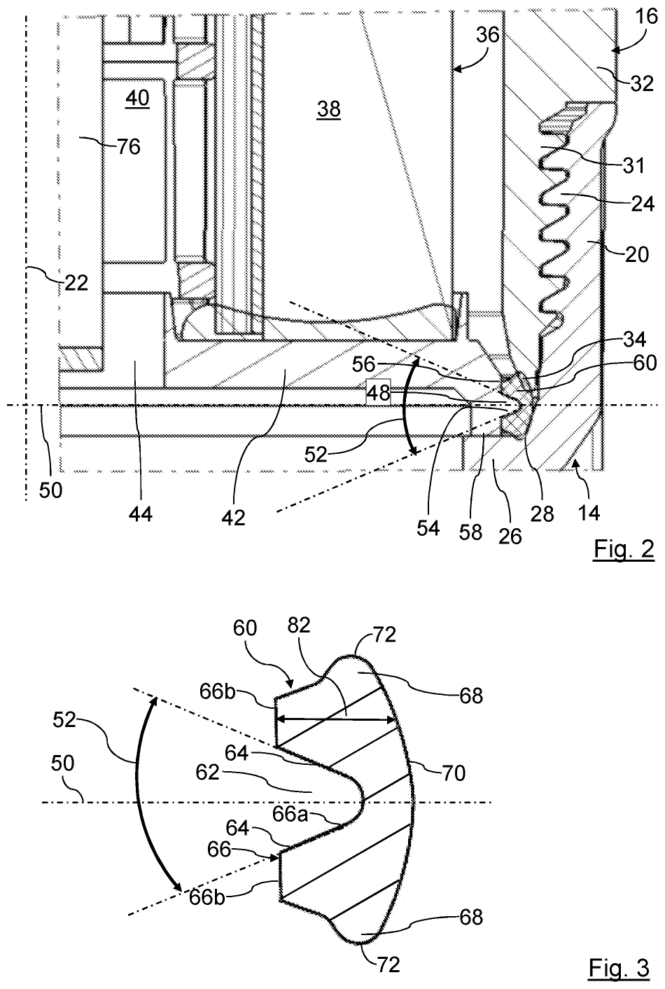

In the final mounted state of the fluid-purifying system 10, which is illustrated in FIGS. 1 and 2, the seal element 60 is compressed between the first housing seal contact surface 28 of the first housing part 14, the second housing seal contact surface 34 of the second housing part 16, and the holding region 46 of the first end body 42. In this context, the radially inner seal element support surface 66 contacts in an areally sealing manner the end body support surface 56. The radially outer seal surface 70 and the top axial seal surface 72 contact respectively in an areally sealing manner the second housing seal contact surface 34 of the second housing part 16. The radially outer seal surface 70 and the bottom axial seal surface 72 contact respectively in an areally sealing manner the first housing seal contact surface 28 of the first housing part 14. In this manner, the raw side 78 of the filter element 36, the collection chamber 30, and the environment 80 are separated mutually from each other. As a whole, three regions are sealingly separated from each other by the seal element 60 in this way.

The raw side 78 is the region inside of the filter housing 12 from where the fluid to be purified flows to the filter medium 38. For example, a part of the raw side 78 is located radially outside of the filter medium 38. The raw side 78 is connected to the fluid inlet of the filter housing 12. The clean side, which is not identified in the Figures, is connected to the fluid outlet of the filter housing 12.

In operation of the fluid-purifying system 10, the fluid to be purified is supplied through the fluid inlet to the raw side 78. The fluid flows in radial direction from the exterior to the interior through the filter medium 38, is purified thereby, and flows into the element interior 40. The purified fluid flows to the water separation device 76 with which possibly contained water is separated. The purified fluid freed from water exits the fluid-purifying system 10 through the fluid outlet.

The separated water exits the element interior 40 through the water drainage opening 44 and flows into the water collection chamber 30. The collected water can be drained through the water drain 18 from the water collection chamber 30.

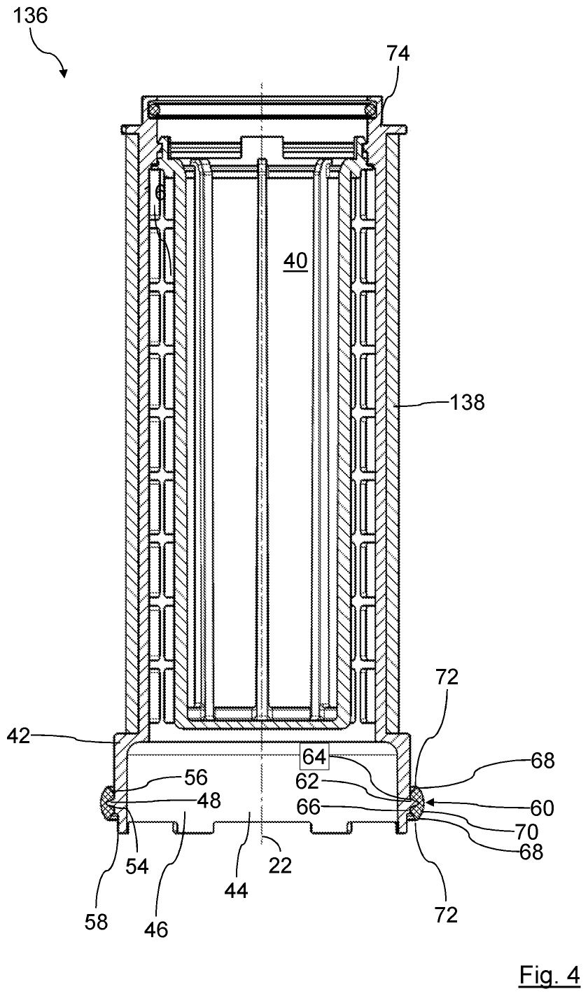

In FIG. 4, a water separation element 136 of a fluid-purifying system according to a second embodiment is illustrated. Those elements that are similar to those of the first embodiment of FIGS. 1 to 3 are provided with the same reference characters. The second embodiment differs from the first embodiment in that the water purifying element 136 is designed exclusively for separation of water. Correspondingly, water separation media 138, for example, coalescence media, are provided instead of the filter medium 38 and surround the element interior 40 circumferentially.

What is claimed is:

1. A fluid-purifying element of a fluid-purifying system for purifying liquid fluid, the fluid-purifying element comprising:
a purifying medium at least partially delimiting an element interior,
a first end body disposed at an axial end face of the purifying medium in relation to an axis of the fluid-purifying element, wherein the first end body comprises a radially outer circumferential side in relation to the axis;
an elastic annular seal element arranged at the radially outer circumferential side of the first end body;
wherein the first end body comprises an end body holding contour configured to hold the seal element, wherein the end body holding contour extends at least in sections continuously circumferentially at the radially outer circumferential side of the first end body;
wherein the seal element comprises a radially inner circumferential side in relation to the axis and a radially outer circumferential side in relation to the axis, wherein the seal element further comprises a seal holding contour arranged at the radially inner circumferential side of the seal element, wherein the seal holding contour of the seal element contacts at least in sections the end body holding contour of the first end body;
wherein the seal element comprises a seal surface extending at least across a portion of the radially outer circumferential side of the seal element;
wherein the end body holding contour of the first end body comprises a protrusion extending at least part-circumferentially and radially outwardly in relation to the axis, wherein the protrusion tapers in a radial direction in relation to the axis from the interior to the exterior;
wherein the seal holding contour of the seal element comprises a V-shaped depression extending at least part-circumferentially and radially outwardly in relation to the axis;
wherein the end body holding contour of the first end body engages at least partially in the seal holding contour of the seal element.

2. The fluid-purifying element according to claim 1, wherein the end body holding contour of the first end body comprises a V-shaped profile or U-shaped profile.

3. The fluid-purifying element according to claim 2, wherein an angle between flanks of the V-shaped profile of the end body holding contour amounts to approximately between 25° and 70°.

4. The fluid-purifying element according to claim 2, wherein an angle between flanks of the V-shaped profile of the end body holding contour amounts to approximately between 25° and 70° and an angle between flanks of the V-shaped depression amounts to approximately between 25° and 70°.

5. The fluid-purifying element according to claim 1, wherein an angle between flanks of the V-shaped depression amounts to approximately between 25° and 70°.

6. The fluid-purifying element according to claim 1, wherein the seal element comprises a seal element support surface disposed at the radially inner circumferential side of the seal element, wherein at least a portion of the seal element support surface is a seal surface.

7. The fluid-purifying element according to claim 1, wherein the first end body comprises an end body support surface at the radially outer circumferential side of the first end body, wherein at least a portion of the end body support surface is a seal surface.

8. The fluid-purifying element according to claim 1, wherein the seal element comprises a seal element support surface disposed at the radially inner circumferential side of the seal element, wherein at least a portion of the seal element support surface is a seal surface, and wherein the first end body comprises an end body support surface at the radially outer circumferential side of the first end body, wherein at least a portion of the end body support surface is a seal surface.

9. The fluid-purifying element according to claim 1, wherein the seal element comprises at least two radially inwardly oriented radial support surface sections arranged on axially oppositely positioned sides in relation to the V-shaped depression.

10. The fluid-purifying element according to claim 1, wherein the end body holding contour of the first end body comprises at least two radially outwardly oriented end body support surfaces arranged on axially oppositely positioned sides in relation to the protrusion.

11. The fluid-purifying element according to claim 1, wherein the seal element comprises at least two radially inwardly oriented radial support surface sections arranged on axially oppositely positioned sides in relation to the V-shaped depression, and wherein the end body holding contour of the first end body comprises at least two radially outwardly oriented end body support surfaces arranged on axially oppositely positioned sides in relation to the protrusion.

12. The fluid-purifying element according to claim 1, wherein the at least two radially inwardly oriented radial support surface sections are symmetrically arranged on the axially oppositely positioned sides in relation to the V-shaped depression, and wherein the at least two radially outwardly oriented end body support surfaces are symmetrically arranged on the axially oppositely positioned sides in relation to the protrusion.

13. The fluid-purifying element according to claim 1, wherein the radially outer circumferential side of the seal element comprises an arc-shaped profile.

14. The fluid-purifying element according to claim 1, wherein the seal element comprises at least one axial end face in relation to the axis and the at least one axial end face comprises a seal surface.

15. The fluid-purifying element according to claim 1, wherein the first end body and the seal element are configured together as a multi-component structure.

16. The fluid-purifying element according to claim 1, wherein the seal element is fastened to the first end body so as to be separable from the first end body.

17. The fluid-purifying element according to claim 1, wherein the seal element is fastened to the first end body so as to be separable from the first end body only destructively.

18. The fluid-purifying element according to claim 1, wherein the first end body comprises at least one fluid connection to the element interior.

19. The fluid-purifying element according to claim 1, wherein the purifying medium is a filter medium surrounding the element interior and wherein a part of a water separation device is arranged in the element interior.

20. The fluid-purifying element according to claim 1, wherein the first end body and the end body holding contour are configured together as one piece.

21. The fluid-purifying element according to claim 1, wherein the first end body and the end body holding contour are configured as a multi-part structure.

22. The fluid-purifying element according to claim 1, further comprising a second end body arranged oppositely to the first end body at the purifying medium axially.

23. A fluid-purifying system for purifying liquid fluid, the fluid-purifying system comprising:
a filter housing comprising a first housing part and a second housing part, wherein the filter housing further comprises a fluid inlet for fluid to be purified and a fluid outlet for purified fluid;
a fluid-purifying element exchangeably arranged in the filter housing such that the fluid-purifying element separates the fluid inlet from the fluid outlet;
wherein the fluid-purifying element comprises a purifying medium at least partially delimiting an element interior and further comprises an end body disposed at an axial end face at the fluid-purifying element in relation to an axis of the fluid-purifying element, wherein the end body comprises a radially outer circumferential side in relation to the axis;
wherein the fluid-purifying element further comprises an elastic annular seal element arranged at the radially outer circumferential side of the end body, wherein the end body comprises an end body holding contour configured to hold the seal element and extending at least in sections continuously circumferentially at the radially outer circumferential side of the end body;
wherein the seal element comprises a radially inner circumferential side in relation to the axis and a radially outer circumferential side in relation to the axis, wherein the seal element comprises a seal holding contour at the radially inner circumferential side of the seal element, wherein the seal holding contour of the seal element contacts at least in sections the end body holding contour of the end body;
wherein the seal element comprises a seal surface extending at least across a portion of the radially outer circumferential side of the seal element;
wherein the seal element sealingly contacts respectively an end body support surface of the end body, a first housing seal contact surface of the first housing part, and a second housing seal contact surface of the second housing part;
wherein the end body holding contour of the end body comprises a protrusion extending at least part-circumferentially and radially outwardly in relation to the axis;
wherein the seal-holding contour of the seal element comprises a V-shaped depression extending at least part-circumferentially and radially outwardly in relation to the axis;
wherein the end body holding contour of the end body engages at least partially in the seal holding contour of the seal element.

24. A seal element of a fluid-purifying element for a fluid-purifying system for purifying liquid fluid, wherein the seal element is elastic and annular, wherein the seal element comprises:
a radially inner circumferential side and a radially outer circumferential side in relation to an axis of the seal element;
a seal holding contour arranged at the radially inner circumferential side;
a seal surface extending at least across a portion of the radially outer circumferential side;
wherein the seal holding contour comprises a V-shaped depression extending at least part-circumferentially and radially outwardly in relation to the axis.
